(19) United States
(12) Patent Application Publication
(10) Pub. No.: US 2007/0211759 A1
(43) Pub. Date: Sep. 13, 2007

(54) Multiplexing device, multiplexing method, and multiplexing program

(75) Inventors: Atsuko Tada, Kawasaki (JP); Tsutomu Togo, Kawasaki (JP); Kazumi Doi, Fukuoka (JP); Hideaki Ishii, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/494,661

(22) Filed: Jul. 28, 2006

(30) Foreign Application Priority Data
Mar. 10, 2006 (JP) 2006-66416

(51) Int. Cl. H04J 3/24

(52) U.S. Cl. 370/474; 370/476

(57) ABSTRACT

The present invention provides a multiplexing device, multiplexing method, and multiplexing program that allow an optional character string to be easily multiplexed with video online. The multiplexing processing unit multiplexes a dummy character string with the respective encoded data for video and audio. The multiplexed data are stored in the multiplexed data storage unit. The multiplexing processing unit stores the position (first dummy point) in which the dummy character string data were stored in the dummy point storage unit. The character string substitution processing unit substitutes the dummy character string data for the optional character string data to be inserted that has been input from the character string input unit on the basis of a first dummy point. The substituted multiplexed data are output as a multiplexed file from the file generation processing unit.

### CROSS-REFERENCE TO RELATED APPLICATIONS

This application is based upon and claims the benefit of priority from the prior Japanese Patent Application No. 2006-66416, filed on Mar. 10, 2006, the entire contents of which are incorporated herein by reference.

### BACKGROUND OF THE INVENTION

1. Field of the Invention

The present invention relates to a multiplexing device that generates a multiplexed file by multiplexing video and audio data and so forth and character strings, as well as a multiplexing method and multiplexing program. The present invention particularly relates to a multiplexing device or the like that is able to generate a multiplexed file by inputting a character string online.

2. Description of the Related Art

Conventionally, technologies that displays by superposing text on video exist. Conventional technologies of this type include, for example, a video signal multiplexing device that, in order to display by superposing a telop constituting a character string on video, compares respective time codes with respect to the time code of the video signal and a telop signal pre-stored in a buffer, and, in the event of a match, multiplexes the telop signal with the video signal (Japanese Patent Application Laid-Open No. H11-225285, for example).

Meanwhile, MPEG (Moving Picture Experts Group)-4 that relates to image compression technology has established the MP4 (MPEG Audio Layer4) file format as the accumulation file format. For example, a file conversion method or the like in which the proportion of the increase in the converted metadata size is estimated when the MP4 file format is generated, free data corresponding to the increase in the additional data is inserted in the header section and the header section is overwritten with new meta data created during MP4 file conversion (Japanese Patent Application Laid-Open No. 2003-173625, for example).

However, Japanese Patent Application Laid-Open No. H11-225285 discloses a technology that creates the telop representing the character string offline and multiplexes the telop with the video signal, but it is not possible to multiplex an optional character string with the video online (real time) while the optional character string is input on viewing the video.

Further, Japanese Patent Application Laid-Open No. 2003-173625 discloses a technology in which the size of the data inserted in the data section of the file is changed so that the amount of memory consumed or the like is not increased. As per Japanese Patent Application Laid-Open No. H11-225285, it is not possible to multiplex an optional character string with video online.

### SUMMARY OF THE INVENTION

Therefore, the present invention is conceived in view of the above problems and an object of the present invention is to provide a multiplexing device, multiplexing method, and multiplexing program that allow an optional character string to be easily multiplexed with video online.

In order to achieve the above object, the present invention is a multiplexing device for generating a multiplexed file by multiplexing first character string data to be inserted in video data with the video data, having: a dummy character string output unit which outputs second character string data constituting a dummy character string; a multiplexing processing unit which multiplexes the second character string data with the video data and outputs the multiplexed data; a substitution processing unit which substitutes the second character string data for the first character string data on the basis of a point in the second character string data in the multiplexed data; and a file generation unit which generates the multiplexed file from the multiplexed data which is substituted for the first character string data.

Further, the present invention is the multiplexing device, further having a character string length designation unit which designates a character string length of the dummy character string.

Further, the present invention is the multiplexing device, further having a point designation unit which designates a plurality of the points, wherein the substitution processing unit substitutes, for each of the plurality of the points, the second character string data for the first character string data that differ for each of the points.

Furthermore, the present invention is the multiplexing device, wherein the dummy character string output unit outputs the dummy character string constituting an empty character string.

Further, the present invention is the multiplexing device, further having a multiplexed data storage unit which stores the multiplexed data, wherein the point is a position in the multiplexed data storage unit when the multiplexed data is stored in the multiplexed data storage unit.

Further, the present invention is the multiplexing device, wherein the substitution processing unit substitutes the first character string data and the second character string data on the basis of the point of the second character string data in the multiplexed file when the multiplexed file is generated by the file generation unit from the multiplexed data.

Further, in order to achieve the above object, the present invention is a multiplexing method for generating a multiplexed file by multiplexing first character string data to be inserted in video data with the video data, having the steps of: multiplexing second character string data constituting a dummy character string that is output from a dummy character string output unit with the video data and outputting the multiplexed data; substituting the second character string data for the first character string data on the basis of the point of the second character string data in the multiplexed data; and generating the multiplexed file from the multiplexed data which is substituted for the first character string data.

Furthermore, in order to achieve the above object, the present invention is a multiplexing program for generates a multiplexed file by multiplexing first character string data to be inserted in video data with the video data, the multiplexing program causing a computer to execute: a multiplexing processing which multiplexes second character string data constituting a dummy character string that is output from a dummy character string output unit with the video data and output the multiplexed data; a substituting processing which substitutes the second character string data for the first character string data on the basis of the point of the second character string data in the multiplexed data; and a file generating processing which generates the multiplexed file from the multiplexed data which is substituted for the first character string data.

The present invention makes it possible to provide a multiplexing device, a multiplexing method, and a multiplexing program that allow an optional character string to be easily multiplexed with video online.

### BRIEF DESCRIPTION OF THE DRAWINGS

FIG. 1 shows a constitutional example of a file generation device to which the present invention is applied;

FIG. 2 shows a constitutional example of a multiplexed file;

FIG. 3 simply shows the operation of the present invention;

FIG. 4 is an example of a flowchart of the multiplexing processing of a dummy character string;

FIG. 5 is an example of a flowchart of character string substitution processing;

FIGS. 6A to 6C serve to illustrate processing to match character strings;

FIG. 7A shows an example of registered dummy character strings and FIG. 7B shows a constitutional example for generating a multiplexed file of empty character strings; and

FIG. 8 shows a constitutional example of a file generation device when a plurality of character string input points can be designated.

### DESCRIPTION OF THE PREFERRED EMBODIMENTS

Preferred embodiments of the present invention will be described hereinbelow with reference to the drawings.

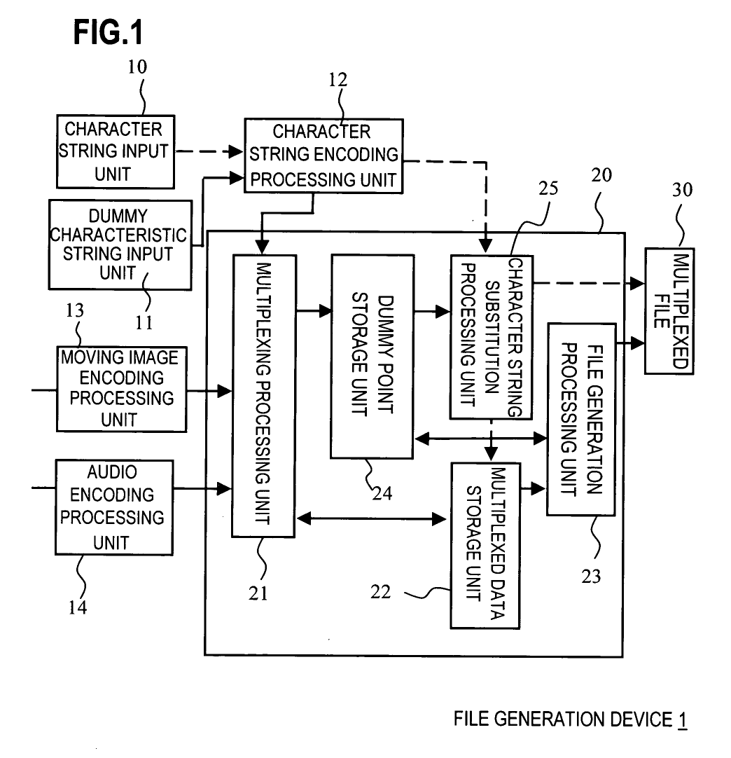

FIG. 1 is a constitutional example of a file generation device 1 to which the present invention is applied. The file generation device 1 has a character string input unit 10, a dummy character string input unit 11, a character string encoding processing unit 12, a moving image encoding processing unit 13, an audio encoding processing unit 14, and a multiplexing file generation unit 20.

The character string input unit 10 is for inputting optional character strings to be inserted by the user, and is a keyboard or the like, for example.

The dummy character string input unit 11 is for inputting dummy character strings. Dummy character strings are pre-stored in memory, for example, and dummy character strings are read and output from the dummy character string input unit 11 as a result of the user operating predetermined buttons or the like that are displayed on the screen. Further, the dummy character string input unit 11 also outputs time information when the dummy character string is output. The time information is the point (time) at which the character string to be inserted is multiplexed with video.

The character string encoding processing unit 12 encodes and outputs character string data to be inserted by the character string input unit 10 and dummy character string data from the dummy character string input unit 11.

The moving image encoding processing unit 13 inputs moving image data (video data) from outside, encodes this data, and outputs. The moving image encoding processing unit 13 performs compression encoding, for example.

The audio encoding processing unit 14 inputs audio data from outside, encoded this data, and outputs. The audio encoding processing unit 14 performs compression encoding, for example.

The multiplexing file generation unit 20 multiplexes the encoded moving image data and audio data and optional character string data to be inserted, and generates a multiplexed file 30 inserted the character string in desired video.

The multiplexing file generation unit 20 has a multiplexing processing unit 21, a multiplexed data storage unit 22, a file generation processing unit 23, a dummy point storage unit 24, and a character string substitution processing unit 25, as shown in FIG. 1.

The multiplexing processing unit 21 inputs the encoded moving image data and audio data, and the encoded dummy character string from the character string encoding processing unit 12, packs these data in a format based on the multiplexed file format, and generates header data. The multiplexing processing unit 21 outputs these data to the multiplexed data storage unit 22 as multiplexed data.

Furthermore, when the multiplexed data are stored in the multiplexed data storage unit 22, the multiplexing processing unit 21 outputs information on the position in which the dummy character string data are stored (a first dummy point, hereinbelow) to the dummy point storage unit 24.

Further, the multiplexing processing unit 21 inserts time information from the character string encoding processing unit 12 in the header section of the multiplexed data and stores the multiplexed data in the multiplexed data storage unit 22.

The multiplexed data storage unit 22 stores the multiplexed data from the multiplexing processing unit 21.

The file generation processing unit 23 reads multiplexed data from the multiplexed data storage unit 22, renders a file in the format of a 3GPP (3^{rd} Generation-Partnership Project) file, and outputs the file as the multiplexed file 30. An example of the 3GPP file format will be described subsequently.

In addition, when generating the multiplexed file 30, the file generation processing unit 23 outputs positional information on the dummy character string data in the multiplexed file 30 (the point to which the dummy character string is written when the multiplexed file 30 is generated, followed by a second dummy point, for example, the position from the file header) to the dummy point storage unit 24.

The dummy point storage unit 24 stores the first dummy point from the multiplexing processing unit 21. Further, when the multiplexed data have already been converted to the file by the file generation processing unit 23, the dummy point storage unit 24 stores the second dummy point from the file generation processing unit 23.

The character string substitution processing unit 25 overwrites the optional character string from the character string encoding processing unit 12 to the region where the dummy character string is written on the basis of the first or second dummy point from the dummy point storage unit 24.

That is, before the multiplexed file 30 is generated, dummy character string data among the multiplexed data stored in the multiplexed data storage unit 22 are substituted for (overwritten with) the character string data to be inserted on the basis of the first dummy point.

Furthermore, after the multiplexed file 30 has been generated, dummy character string data in the multiplexed file 30 are substituted for (overwritten with) the character string data to be inserted, on the basis of the second dummy point. The multiplexed file 30 is stored in memory after being generated by the file generation processing unit 23, and the character string substitution processing unit 25 accesses the memory and substitutes the data for the character string data to be inserted. The character string substitution processing unit 25 outputs the overwritten multiplexed file 30 as is without passing the overwritten multiplexed file 30 via the file generation processing unit 23.

The multiplexed file 30 generated by the file generation device 1 is output to a server or the like and read from the server or the like at an optional time and listened to.

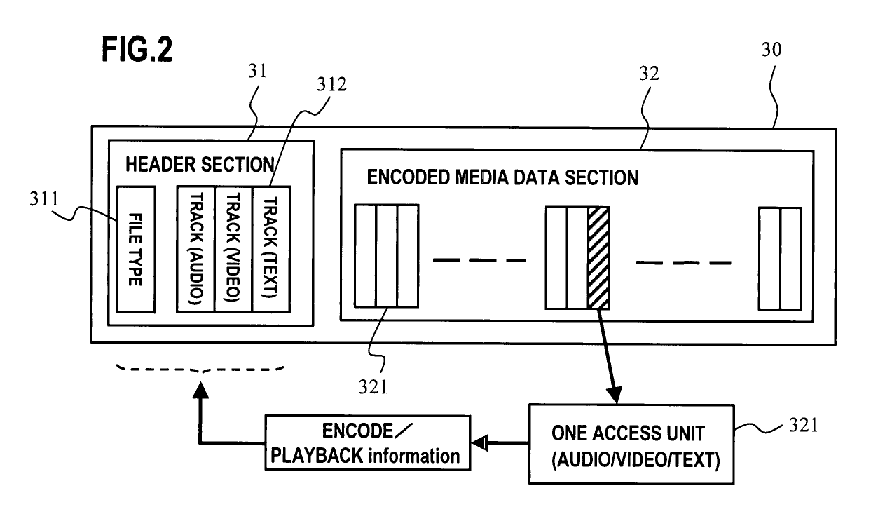

FIG. 2 is an example of the multiplexed file 30 in the 3GPP file format. The 3GPP file is a file which extends the MP4 file format specified by MPEG-4 of the ISO (International Organization for Standardization) standard and is the preferred file format for mobile terminals such as cellular phones and PDAs (Personal Digital Assistants).

As shown in FIG. 2, the multiplexed file 30 is constituted by a header section 31 and a media data section 32.

The header section 31 has a file type region 311 in which the file type is stored and track regions 312 for video, audio, and text.

The file type is an information indicating the method and means (MP4ver.1, MP4 Ver.2 or the like) of downloading the multiplexed file 30. Further, the drive region 312 stores reproducing order, display time interval information related to each access unit 321, and offset information and so forth indicating in which position in the multiplexed file 30 the access unit is stored.

The media data section 32 stores media data (the respective data for video, audio and text) for each access unit 321. Substituted character strings and dummy character strings are also stored in the media data section 32.

In the multiplexed file 30, the respective data for the required video, audio, text (also including substituted character strings) can be read from the file 30 by searching the tracks stored in the track regions 312 of the header section 31.

In the 3GPP file, the order of the access units 321 is not regulated. Data of the media data section 32 is reproduced while reading the reproducing order by accessing the track 312 of the header section 31. However, in order to reproduce the file while downloading the multiplexed file 30 in interleave-adapted reproducing, the access units 321 desirably stand in a line in order of reproducing.

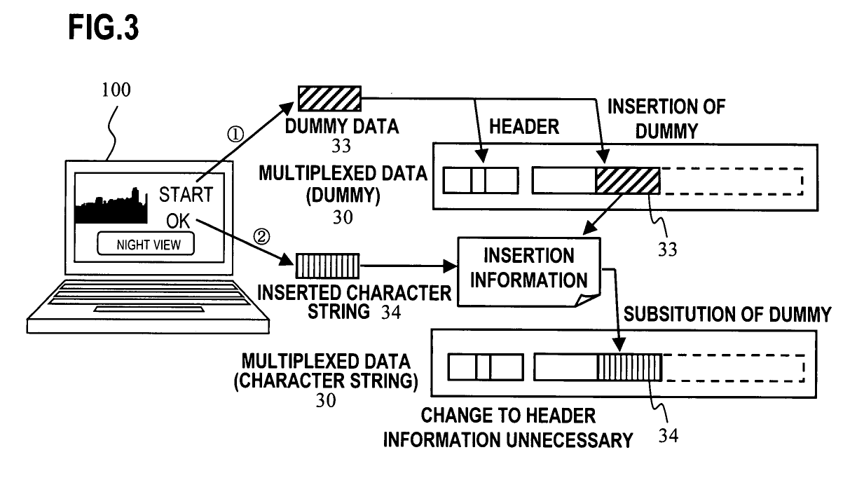

FIG. 3 is a conceptual view of the operation of this embodiment. A personal computer (PC, hereinbelow) 100 shown in FIG. 3 has the constitution of the multiplexing file generation unit 20 of the file generation device 1.

Encoded video and audio data are input to the PC100 as required. The video is displayed on the screen of the PC100.

When the user wishes to input a character string to the desired video, the user operates the ‘start’ button displayed on the screen. Thereupon, the PC100 reads dummy data 33 stored in a memory and generates multiplexed data. By operating the ‘start’ button, a time at which the character string is to be multiplexed is designated and the time information is inserted in the track 312 of the header section 31.

The user then inputs the optional character string to be inserted in a predetermined region that is displayed on the screen. In FIG. 3, the character string is input as ‘night view . . . ’. The multiplexed file 30 is generated during the character string input.

Following the character string input, the user operates the ‘OK’ button on the screen. The optional character string to be inserted is determined as a result of this operation. The PC100 then performs dummy character string substitution processing. Thereafter, the final multiplexed file 30 is generated.

In this case, because processing ends only as a result of the character string substitution processing and processing such as header data rewriting is not required, the processing can be performed rapidly and the optional character string can be easily multiplexed online.

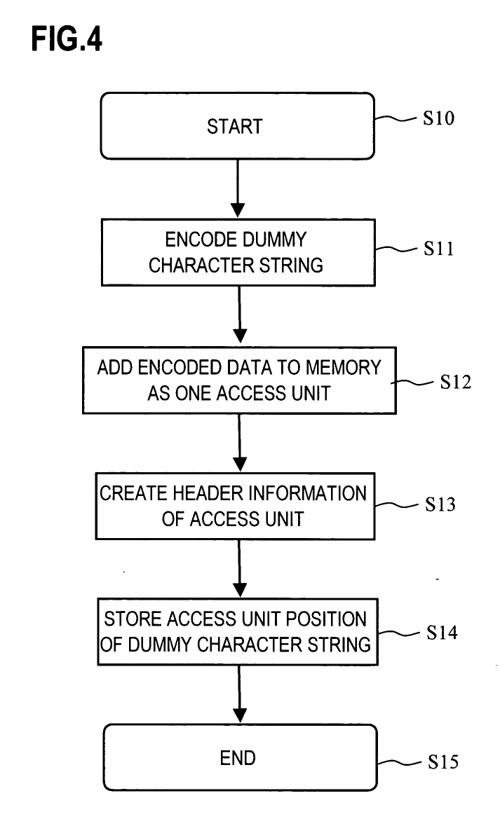

FIG. 4 is an example of a flowchart showing the operation of dummy character string multiplexing processing. The operation is executed by the file generation device 1 in FIG. 1.

As a result of operating the ‘start’ button, the point (time) at which the character string to be inserted is to be multiplexed is indicated and the processing is started (S10).

Thereafter, the dummy character string input unit 11 outputs the dummy character string and the character string encoding processing unit 12 encodes the dummy character string (S11).

The multiplexing processing unit 21 stores the encoded dummy character string data as one access unit in the multiplexed data storage unit 22 (S12).

Thereafter, the multiplexing processing unit 21 creates header information on the basis of the time information and so forth from the character string encoding processing unit 12 (S13).

Thereafter, the multiplexing processing unit 21 stores the position of the access unit when the dummy character string data is stored in the multiplexed data storage unit 22 (first dummy point) in the dummy point storage unit 24 (S14).

The operation of the dummy character string multiplexing processing then ends (S15).

As a result of this processing, the dummy character string data is multiplexed together with video and audio data, and these data are stored in the multiplexed data storage unit 22. Further, the first dummy point is stored in the dummy point storage unit 24.

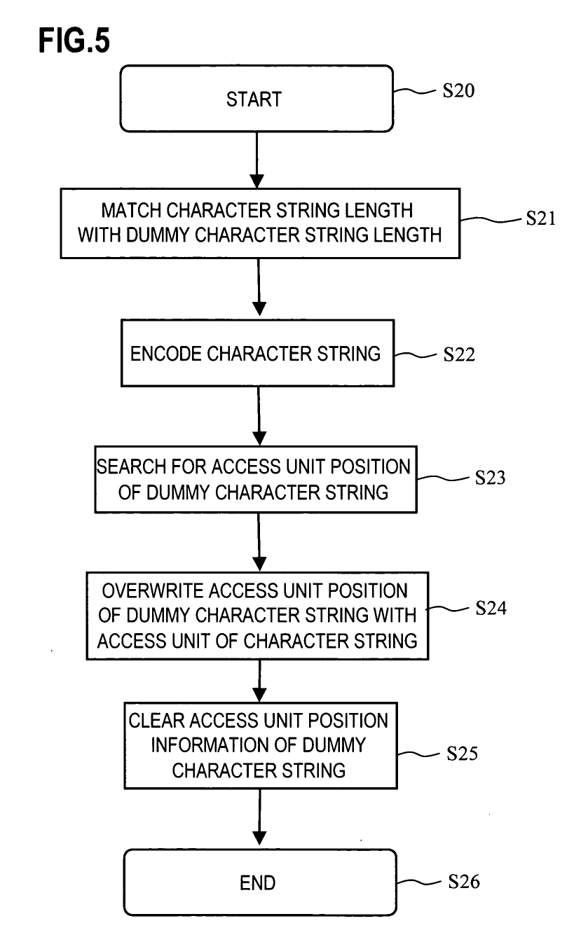

FIG. 5 is an example of a flowchart showing the operation of character string substitution processing.

When the processing is started as a result of operating the ‘OK’ button (S20), the character string encoding processing unit 12 performs processing to match the optional character string data to be inserted that are output by the character string input unit 10 with the length of the dummy character string (S21).

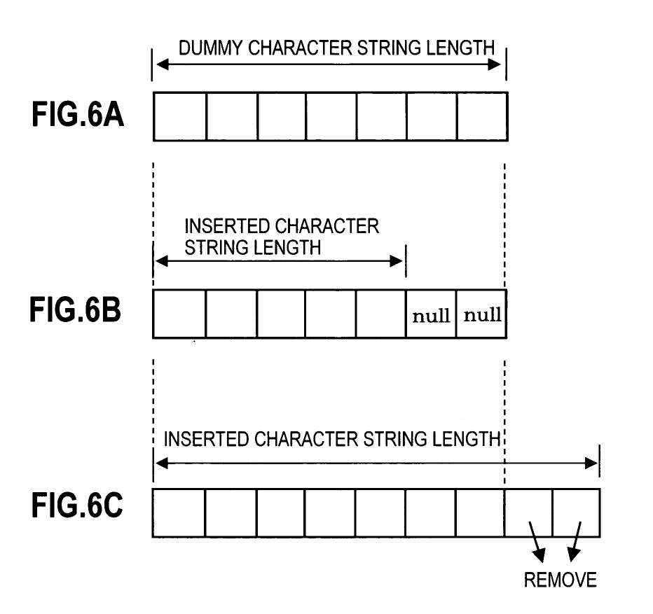

For example, when the dummy character string is of the length shown in FIG. 6A and when the optional character string length to be inserted is shorter than the dummy character string length, the empty character string ‘null’ is inserted so that the optional character string length matches the dummy character string length (See FIG. 6B).

On the other hand, when the length of the inserted character string is longer than the dummy character string length, the part exceeding the dummy character string length is removed so that the inserted character string length matches the dummy character string length (FIG. 6C).

For example, the processing of matching with the length of the dummy character string is performed to retain information related to the character string length by the character string encoding processing unit 12 and refer this information during this processing. Further, the processing is advanced as is when both character string lengths are the same.

Returning now to FIG. 5, the character string encoding processing unit 12 encodes the optional character string to be inserted (S22).

Thereafter, the character string substitution processing unit 25 searches for the access unit position of the dummy character string (S23). The character string substitution processing unit 25 performs the search based on the first dummy point before the multiplexed file 30 is generated and based on the second dummy point after the multiplexed file 30 is generated.

The character string substitution processing unit 25 then overwrites the access unit position of the dummy character string with the access unit of the optional character string (S24). The character string substitution processing unit 25 accesses and overwrites the multiplexed data storage unit 22 before the multiplexed file 30 is generated. The character string substitution processing unit 25 accesses and overwrites the multiplexed file 30 stored in the file generation processing unit 23 after the multiplexed file 30 is generated.

Thereafter, the character string substitution processing unit 25 clears the access unit position information of the dummy character string (S25). The operation of the character string substitution processing then ends (S26).

Thus, when the character string inserted in the video is created in this embodiment, the multiplexed file 30 is generated by executing processing to perform multiplexing and produce a file by using the dummy character string and to optionally substitute (overwrite) the dummy character string for the optional character string to be inserted after the creation of the character string is complete. Hence, there is no need to especially rerecord the video data or the like offline and text can be inserted in real time while the video or the like is online. Accordingly, multiplexing and file rendition of optional character strings can be easily performed by means of online processing, whereby convenience is also increasing.

Further embodiments will be described next. In the above example, the length of the character string to be inserted is described as a predetermined length. The user may otherwise designate the length of the dummy character string.

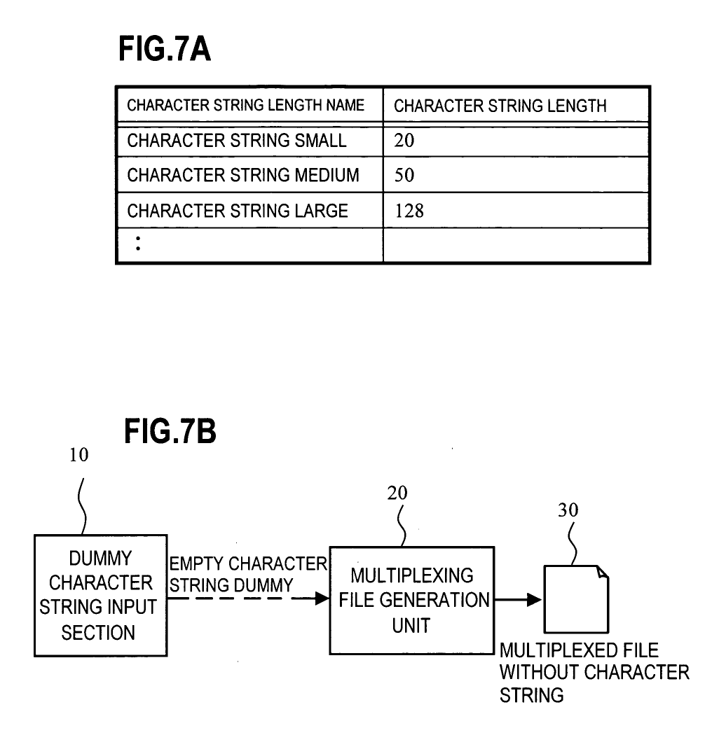

First, the dummy character string length is registered. For example, the dummy character string length is registered as a result of the user designating the character string via the character string input unit 10 of the file generation device 1. An example of the registered character string length is shown in FIG. 7A. The information is stored in the character string encoding processing unit 12 and referenced during the processing (S21 in FIG. 5) of matching with the dummy character string length of the character string substitution processing.

Thereafter, processing similar to the above processing is performed to generate the multiplexed file 30.

According to this example, because the user is able to designate the dummy character string length, the length of the character string to be inserted can also be changed in accordance with the user's preferences. Therefore, character strings of a variety of lengths can be inserted in video and convenience increases.

The information of the registered character string length may be stored in the character string input unit 10, the dummy character string input unit 11, or the character string substitution processing unit 25.

Further, as a further embodiment, a plurality of points at which the character string is inserted can be designated.

For example, as shown in FIG. 3, video in which another character string is to be inserted is sometimes displayed right at the point during the character string is being input by operating the ‘start’ button. In this case, the character string can be input by operating the ‘start’ button once again. A row for inputting a special character string is displayed on the screen when the ‘start’ button is operated once again and a state where the character string can be input is assumed.

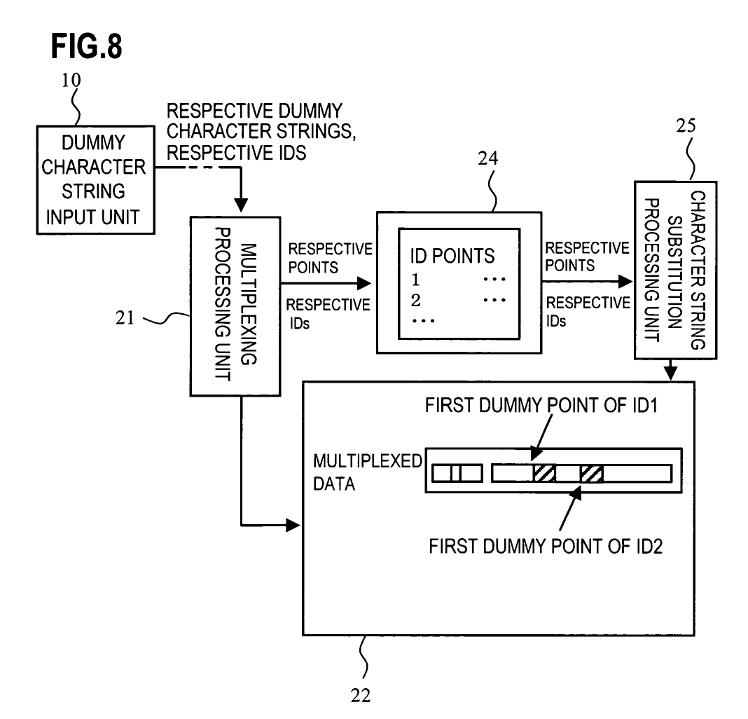

FIG. 8 is a constitutional example of the principal parts of the file generation device 1 of this example. Each time the ‘start’ button is operated instead of operating the ‘OK’ button, the dummy character string is output from the dummy character string input unit 11. Thereupon, an ID that permits a distinction from other dummy character strings is also output. The multiplexing processing unit 21 generates multiplexed data together with video data or the like and stores the multiplexed data in the multiplexed data storage unit 22. FIG. 8 shows an example in which the multiplexed data with a plurality of first dummy points is stored.

The multiplexing processing unit 21 outputs each of the first dummy points and the respective IDs to the dummy point storage unit 24. As shown in FIG. 8, the dummy point storage unit 24 stores data resulting from pairing the respective first dummy points and the respective IDs as a table format. The character string substitution processing unit 25 reads the respective first dummy points and the respective IDs from the dummy point storage unit 24. Further, the character string substitution processing 25 substitutes with the character string to be inserted differentially at each of the first dummy points on the basis of the respective first dummy point corresponding with the respective IDs. The ID may also be added to the character string to be inserted and the first dummy points matching the IDs may be substituted with optional respective character strings.

In this example, a plurality of character strings can be input in parallel before the inputting of the character string is complete, whereby convenience is further improved.

As a further embodiment, the dummy character string output by the dummy characteristic string input unit 11 can also be an empty character string.

FIG. 7B is a constitutional example of the principal parts of the file generation device 1 that illustrates this example. The dummy character string input unit 11 designs the dummy character string of the empty character string. The multiplexing file generation unit 20 generates the multiplexed file 30 from the dummy character string of the empty character string. The generated multiplexed file 30 is the file of the empty character string.

For example, in cases where the character string insertion is cancelled during the character string to be inserted is being input, when the dummy character string is represented by some kind of character string, the multiplexed file 30 in which the dummy character string itself has been inserted is generated and the dummy character string ends up being displayed in the video. By rendering the dummy character string the empty character string (‘null’, for example), the dummy character string cannot be displayed in the video even when the insertion of the character string is stopped midway through. Convenience therefore improves.

In addition, the abovementioned example described the storage of information on the dummy character string length in the character string encoding processing unit 12 in the processing (S21 in FIG. 5) of matching the optional character string length with the dummy character string length. Naturally, the information on the dummy character string length may also be stored in the dummy characteristic string input unit 11 in addition to the character string encoding processing unit 12 and the information on the dummy character string length may be stored in the character string substitution processing unit 25 and processing of matching the character string length may be performed by this processing unit 25. The same operations and effects as in the above example are exhibited in either case.

In addition, the abovementioned example was described by taking memory positions or positions in the file (positions from the file header) as examples of the first and second dummy points. Time information, for example, may also be used for the dummy points in addition to the positional information. For example, time information from the dummy characteristic string input unit 11 may also be stored in the dummy point storage unit 24 or the like as the first and second dummy points and the processing may be performed. The same operations and effects as in the earlier examples are also afforded in this case.

Furthermore, the above examples were described with the 3GPP file format serving as the example of the multiplexed file 30. Naturally, the MP4 file format is also acceptable. Any file format is possible as long as the file is capable of handling video and character string inserted in video. The same operations and effects as in the earlier examples are also afforded in this case.

Moreover, data rendered by multiplexing character string data to be inserted in video and the respective data for video and audio may also be output except file format. In this case, for example, the file generation device 1 has a constitution that does not comprise the file generation processing unit 23.

In addition, processing can be executed in the same way as in the above example and the same operations and effects are afforded.

What is claimed is:

1. A multiplexing device for generating a multiplexed file by multiplexing first character string data to be inserted in video data with the video data, comprising:
a dummy character string output unit which outputs second character string data constituting a dummy character string;
a multiplexing processing unit which multiplexes the second character string data with the video data and outputs the multiplexed data;
a substitution processing unit which substitutes the second character string data for the first character string data on the basis of a point in the second character string data in the multiplexed data; and
a file generation unit which generates the multiplexed file from the multiplexed data which is substituted for the first character string data.

2. The multiplexing device according to claim 1, further comprising:
a character string length designation unit which designates a character string length of the dummy character string.

3. The multiplexing device according to claim 1, further comprising:
a point designation unit which designates a plurality of the points,
wherein the substitution processing unit substitutes, for each of the plurality of the points, the second character string data for the first character string data that differ for each of the points.

4. The multiplexing device according to claim 1, wherein the dummy character string output unit outputs the dummy character string constituting an empty character string.

5. The multiplexing device according to claim 1, further comprising:
a multiplexed data storage unit which stores the multiplexed data,
wherein the point is a position in the multiplexed data storage unit when the multiplexed data is stored in the multiplexed data storage unit.

6. The multiplexing device according to claim 1, wherein the substitution processing unit substitutes the first character string data and the second character string data on the basis of the point of the second character string data in the multiplexed file when the multiplexed file is generated by the file generation unit from the multiplexed data.

7. A multiplexing method for generating a multiplexed file by multiplexing first character string data to be inserted in video data with the video data, comprising the steps of:
multiplexing second character string data constituting a dummy character string that is output from a dummy character string output unit with the video data and outputting the multiplexed data;
substituting the second character string data for the first character string data on the basis of the point of the second character string data in the multiplexed data; and
generating the multiplexed file from the multiplexed data which is substituted for the first character string data.

8. A multiplexing program for generating a multiplexed file by multiplexing first character string data to be inserted in video data with the video data, the multiplexing program causing a computer to execute:
a multiplexing processing which multiplexes second character string data constituting a dummy character string that is output from a dummy character string output unit with the video data and output the multiplexed data;
a substituting processing which substitutes the second character string data for the first character string data on the basis of the point of the second character string data in the multiplexed data; and
a multiplexed file generating processing which generates the multiplexed file from the multiplexed data in which is substituted for the first character string data.
